(19) United States
(12) Patent Application Publication
(10) Pub. No.: US 2026/0018841 A1
(43) Pub. Date: Jan. 15, 2026

(54) BUSBAR WITH FINGER-PROOF TERMINAL CONNECTOR

(71) Applicant: GM Global Technology Operations LLC, Detroit, MI (US)

(72) Inventors: Kevin James Lapprich, Sterling Heights, MI (US); Robert J. Heydel, Clawson, MI (US); Benjamin Mulder, Madison Heights, MI (US)

(21) Appl. No.: 18/768,457

(22) Filed: Jul. 10, 2024

(51) Int. Cl. H01R 25/16; B60R 16/03

(52) U.S. Cl. CPC H01R 25/162; B60R 16/03; H01R 2201/26

(57) ABSTRACT

A busbar assembly for interconnecting components within a multi-module electrical system for a vehicle includes a busbar having a first distal end and a second distal end, and a first finger-proof terminal connector positioned on the first distal end of the busbar and adapted to electrically connect the busbar to an external terminal, wherein the finger-proof terminal connecter is adapted to allow limited movement of the first distal end of the busbar relative to the first finger-proof terminal connector within an x-y plane.

### INTRODUCTION

The present invention relates generally to electrochemical energy storage devices such as Li-ion batteries, and more particularly to a busbar adapted to facilitate bolted module-to-module connections between electrochemical components.

Bolted electrical terminal designs integrate low-profile, finger-proofing features to prevent inadvertent contact between an electrified terminal surface and an operator or a tool. These finger-proof electrical terminals allow for safe and simplified battery pack assembly along with improved voltage scalability in a multi-module battery pack. However, assembly of electric vehicles and corresponding battery modules are often done with automation, requiring precise placement of modules that are to be connected.

Thus, while current terminal connectors achieve their intended purpose, there is a need for a new and improved busbar having a finger-proof terminal connector that allows sliding movement of a distal end of the busbar relative to the finger-proof terminal connector within an x-y plane, allowing automated assembly of modular battery systems with less precise placement and dimensional tolerancing of components of the modular battery system.

### SUMMARY

According to several aspects, a busbar assembly for interconnecting components within a multi-module electrical system for a vehicle according to an exemplary embodiment of the present disclosure includes a busbar having a first distal end and a second distal end, and a first finger-proof terminal connector positioned on the first distal end of the busbar and adapted to electrically connect the busbar to an external terminal, wherein the finger-proof terminal connecter is adapted to allow limited movement of the first distal end of the busbar relative to the first finger-proof terminal connector within an x-y plane.

According to another aspect, the busbar includes a first slot formed therein and positioned longitudinally along a central axis of the busbar adjacent the first distal end of the busbar, a second slot formed therein and positioned longitudinally along the central axis of the busbar adjacent the first slot, and a protective outer coating extending along a length of the busbar, the first distal end of the busbar, including the first slot and the second slot, extending beyond the protective outer coating, wherein the finger-proof terminal connector encapsules the first distal end of the busbar, including the first slot and the second slot, and extends over a first edge of the protective outer coating.

According to another aspect, the first finger-proof terminal connector includes an upper terminal cap and a lower terminal cap, the upper terminal cap and the lower terminal cap including features adapted to secure the upper cap to the lower cap with the first distal end of the busbar encapsulated therebetween, the upper terminal cap of the first finger-proof terminal connector including a fastener retaining cap with features adapted to rotatably secure a terminal fastener therein, wherein the terminal fastener extends through the first slot within the busbar, an alignment post extending through the second slot within the busbar and engaging a limit stop slot formed within the lower terminal cap, the lower terminal cap of the first finger-proof terminal connector including a terminal barrel supported within an aligning pocket formed therein, the terminal barrel adapted to engage an external terminal and including a contact face in contact with the busbar and adapted to create an electrical connection therebetween, wherein the terminal fastener extends through the contact face of the terminal barrel and is adapted to engage an external terminal and secure the first distal end of the busbar and the first finger-proof terminal connector to the external terminal and creating an electrical connection between the busbar and the external terminal through the terminal barrel.

According to another aspect, the first slot has a width and a length that are each larger than a diameter of the terminal fastener extending therethrough, and the second slot has a width and a length that are each larger than a diameter of the alignment post extending therethrough, wherein prior to the terminal fastener being secured to an external terminal, the first distal end of the busbar is moveable relative to the first finger-proof terminal connector within the x-y plane.

According to another aspect, the upper terminal cap of the first finger-proof terminal connector includes a pick and place feature adapted to allow grasping of the busbar assembly by an automated tool, wherein, when the busbar assembly is being supported by an automated tool grasping the pick and place feature of the upper terminal cap of the first finger-proof terminal connector, the busbar is moveable relative to the first finger-proof terminal connector within the x-y plane.

According to another aspect, the outer protective cover of the busbar includes a pick and place feature adapted to allow grasping of the busbar assembly by an automated tool, wherein, when the busbar assembly is being supported by an automated tool grasping the pick and place feature of the outer protective coating of the busbar, the first finger-proof terminal connector is moveable relative to the busbar within the x-y plane.

According to another aspect, the busbar assembly further includes a second finger-proof terminal connector positioned on the second distal end of the busbar and adapted to electrically connect the busbar to an external terminal, wherein the second finger-proof terminal connecter is adapted to allow limited movement of the second distal end of the busbar relative to the second finger-proof terminal connector within the x-y plane.

According to another aspect, the busbar further includes a third slot formed therein and positioned longitudinally along the central axis of the busbar adjacent the second distal end of the busbar, and a fourth slot formed therein and positioned longitudinally along the central axis of the busbar adjacent the third slot, and wherein, the protective outer coating extends along a length of the busbar, the second distal end of the busbar, including the third slot and the fourth slot, extending beyond the protective outer coating, wherein the second finger-proof terminal connector encapsules the second distal end of the busbar, including the third slot and the fourth slot, and extends over a second edge of the protective outer coating.

According to another aspect, the second finger-proof terminal connector includes an upper terminal cap and a lower terminal cap, the upper terminal cap and the lower terminal cap including features adapted to secure the upper cap to the lower cap with the second distal end of the busbar encapsulated therebetween, the upper terminal cap of the second finger-proof terminal connector including a fastener retaining cap with features adapted to rotatably secure a terminal fastener therein, wherein the terminal fastener extends through the third slot within the busbar, an alignment post extending through the fourth slot within the busbar and engaging a limit stop slot formed within the lower terminal cap of the second finger-proof terminal connector, the lower terminal cap of the second finger-proof terminal connector including a terminal barrel supported within an aligning pocket formed therein, the terminal barrel adapted to engage an external terminal and including a contact face in contact with the busbar and adapted to create an electrical connection therebetween, wherein the terminal fastener extends through the contact face of the terminal barrel and is adapted to engage an external terminal and secure the second distal end of the busbar and the second finger-proof terminal connector to the external terminal and creating an electrical connection between the busbar and the external terminal through the terminal barrel.

According to another aspect, the third slot has a width and a length that are each larger than a diameter of the terminal fastener extending therethrough, and the fourth slot has a width and a length that are each larger than a diameter of the alignment post extending therethrough, wherein prior to the terminal fastener being secured to an external terminal, the second distal end of the busbar is moveable relative to the second finger-proof terminal connector within the x-y plane.

According to another aspect, the upper terminal cap of the second finger-proof terminal connector includes a pick and place feature adapted to allow grasping of the busbar assembly by an automated tool, wherein, when the busbar assembly is being supported by an automated tool grasping the pick and place feature of the upper terminal cap of the second finger-proof terminal connector, the busbar is moveable relative to the second finger-proof terminal connector within the x-y plane, and when the busbar assembly is being supported by an automated tool grasping the pick and place feature of the outer protective coating of the busbar, each of the first finger-proof terminal connector and the second finger-proof terminal connector is independently moveable relative to the busbar within the x-y plane.

According to another aspect, the fastener retaining cap of each of the first finger-proof terminal connector and the second finger-proof terminal connector includes external threads adapted to engage internal threads of a pyrophoric cap, the pyrophoric cap adapted to removably cover an opening within the fastener retaining cap, the opening within the fastener retaining cap adapted to allow access to the terminal fastener.

According to several aspects, a busbar assembly for interconnecting components within a multi-module electrical system for a vehicle according to an exemplary embodiment of the present disclosure includes a busbar having a first distal end and a second distal end, a first finger-proof terminal connector positioned on the first distal end of the busbar and adapted to electrically connect the busbar to an external terminal, wherein the finger-proof terminal connecter is adapted to allow limited movement of the first distal end of the busbar relative to the first finger-proof terminal connector within an x-y plane, and a second finger-proof terminal connector positioned on the second distal end of the busbar and adapted to electrically connect the busbar to an external terminal, wherein the second finger-proof terminal connecter is adapted to allow limited movement of the second distal end of the busbar relative to the second finger-proof terminal connector within the x-y plane.

According to another aspect, the busbar includes a first slot formed therein and positioned longitudinally along a central axis of the busbar adjacent the first distal end of the busbar, a second slot formed therein and positioned longitudinally along the central axis of the busbar adjacent the first slot, a third slot formed therein and positioned longitudinally along the central axis of the busbar adjacent the second distal end of the busbar, a fourth slot formed therein and positioned longitudinally along the central axis of the busbar adjacent the third slot, a protective outer coating extending along a length of the busbar, the first distal end of the busbar, including the first slot and the second slot, extending beyond the protective outer coating, wherein the first finger-proof terminal connector encapsules the first distal end of the busbar, including the first slot and the second slot, and extends over a first edge of the protective outer coating, and the second distal end of the busbar, including the third slot and the fourth slot, extending beyond the protective outer coating, wherein the second finger-proof terminal connector encapsules the second distal end of the busbar, including the third slot and the fourth slot, and extends over a second edge of the protective outer coating.

According to another aspect, the first finger-proof terminal connector is substantially identical to the second finger-proof terminal connector, each of the first finger-proof terminal connector and the second finger-proof terminal connector including an upper terminal cap and a lower terminal cap, the upper terminal cap and the lower terminal cap including features adapted to secure the upper cap to the lower cap with the distal end of the busbar encapsulated therebetween, the upper terminal cap of each of the first finger-proof terminal connector and the second finger-proof terminal connector including a fastener retaining cap with features adapted to rotatably secure a terminal fastener therein, wherein the terminal fastener of the first finger-proof terminal connector extends through the first slot within the busbar and the terminal fastener of the second finger-proof terminal connector extends through the third slot within the busbar, an alignment post, the alignment post of the first finger-proof terminal connector extending through the second slot within the busbar and engaging a limit stop slot formed within the lower terminal cap of the first finger-proof terminal connector, and the alignment post of the second finger-proof terminal connector extending through the fourth slot within the busbar and engaging a limit stop slot formed within the lower terminal cap of the second finger-proof terminal connector, the lower terminal cap of each of the first finger-proof terminal connector and the second finger-proof terminal connector including a terminal barrel supported within an aligning pocket formed therein, the terminal barrel of each of the first finger-proof terminal connector and the second finger-proof terminal connector adapted to engage an external terminal and including a contact face in contact with the busbar and adapted to create an electrical connection therebetween, wherein the terminal fastener of the first finger-proof terminal connector extends through the contact face of the terminal barrel and is adapted to engage an external terminal and secure the first distal end of the busbar and the first finger-proof terminal connector to the external terminal and create an electrical connection between the first distal end of the busbar and the external terminal through the terminal barrel, and the terminal fastener of the second finger-proof terminal connector extends through the contact face of the terminal barrel and is adapted to engage an external terminal and secure the second distal end of the busbar and the second finger-proof terminal connector to the external terminal and create an electrical connection between the second distal end of the busbar and the external terminal through the terminal barrel.

According to another aspect, the first slot has a width and a length that are each larger than a diameter of the terminal fastener of the first finger-proof terminal connector extending therethrough, and the second slot has a width and a length that are each larger than a diameter of the alignment post of the first finger-proof terminal connector extending therethrough, wherein prior to the terminal fastener of the first finger-proof terminal connector being secured to an external terminal, the first distal end of the busbar is moveable relative to the first finger-proof terminal connector within the x-y plane, and the third slot has a width and a length that are each larger than a diameter of the terminal fastener of the third finger-proof terminal connector extending therethrough, and the fourth slot has a width and a length that are each larger than a diameter of the alignment post of the second finger-proof terminal connector extending therethrough, wherein prior to the terminal fastener of the second finger-proof terminal connector being secured to an external terminal, the second distal end of the busbar is moveable relative to the second finger-proof terminal connector within the x-y plane.

According to another aspect, the upper terminal cap of the first finger-proof terminal connector includes a pick and place feature adapted to allow grasping of the busbar assembly by an automated tool, wherein, when the busbar assembly is being supported by an automated tool grasping the pick and place feature of the upper terminal cap of the first finger-proof terminal connector, the busbar is moveable relative to the first finger-proof terminal connector within the x-y plane, the upper terminal cap of the second finger-proof terminal connector includes a pick and place feature adapted to allow grasping of the busbar assembly by an automated tool, wherein, when the busbar assembly is being supported by an automated tool grasping the pick and place feature of the upper terminal cap of the second finger-proof terminal connector, the busbar is moveable relative to the second finger-proof terminal connector within the x-y plane, and the outer protective cover of the busbar includes a pick and place feature adapted to allow grasping of the busbar assembly by an automated tool, wherein, when the busbar assembly is being supported by an automated tool grasping the pick and place feature of the outer protective coating of the busbar, each of the first finger-proof terminal connector and the second finger-proof terminal connector are independently moveable relative to the busbar within the x-y plane.

According to another aspect, the fastener retaining cap of each of the first finger-proof terminal connector and the second finger-proof terminal connector includes external threads adapted to engage internal threads of a pyrophoric cap, a pyrophoric cap of the first finger-proof terminal connector adapted to removably cover an opening within the fastener retaining cap of the first finger proof terminal connector that is adapted to allow access to the terminal fastener of the first finger-proof terminal connector, and a pyrophoric cap of the second finger-proof terminal connector adapted to removably cover an opening within the fastener retaining cap of the second finger proof terminal connector that is adapted to allow access to the terminal fastener of the second finger-proof terminal connector.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having an electrical system including a busbar assembly in accordance with an exemplary embodiment of the present disclosure;

FIG. 2 is a perspective view of a busbar assembly according to and exemplary embodiment of the present disclosure;

FIG. 3 is a perspective view of the busbar assembly shown in FIG. 1, wherein a first finger-proof terminal connector of the busbar assembly is attached to an external terminal of a battery module;

FIG. 4 is section view representing either one of identical first and second finger-proof terminal connectors according to an exemplary embodiment;

FIG. 5 is an exploded view of FIG. 4;

FIG. 6 is a top view representing either one of identical first and second distal ends of a busbar of the busbar assembly;

FIG. 7A is a side sectional view of the first and second finger-proof terminal connectors, wherein a terminal fastener is not threaded into an external terminal; and

FIG. 7B is a side sectional view of the first and second finger-proof terminal connectors, wherein the terminal fastener is threaded into the external terminal.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

In addition, disclosure of ranges includes disclosure of all values and further divided ranges within the entire range, including endpoints and sub-ranges given for the ranges.

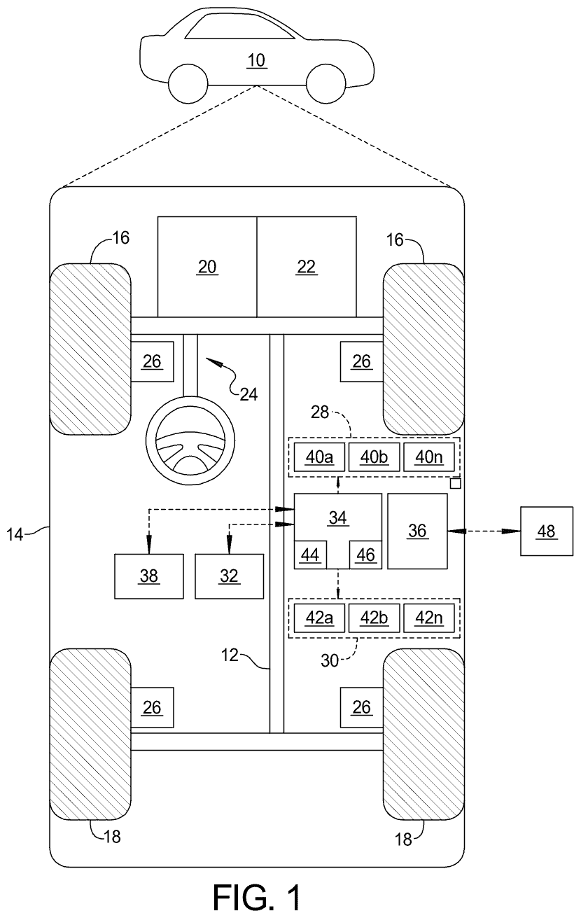

Example embodiments will now be described more fully with reference to the accompanying drawings. In accordance with an exemplary embodiment, FIG. 1 shows a vehicle 10 with a busbar assembly 50 for interconnecting components within a multi-module electrical system 38. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The vehicle 10 includes an electrical system 38. In a hybrid or full-electric vehicle, the engine assembly, fuel supply system, and exhaust system of an ICE-based vehicle are replaced with a single or multiple electrical motors, a battery pack, and battery cooling and charging hardware of the electrical system 38. Many hybrid electric and full electric vehicles employ a rechargeable battery pack to store and supply the requisite power for operating motors of an electric propulsion system 20. In order to generate tractive power with sufficient vehicle range and speed, a battery pack is significantly larger, more powerful, and higher in capacity (Amp-hr) than a standard 12-volt starting, lighting, and ignition (SLI) battery. Compared to the single cell of an SLI battery, contemporary battery packs for electric vehicles group stacks of battery cells into individual battery modules, which are then mounted onto the vehicle chassis 12, e.g., by a battery pack housing or support tray. Modules made up of stacked electrochemical battery cells may be connected in series or parallel through use of an electrical interconnect board (ICB), or modules may be connected directly to one another. Individual battery modules are electrically connected together via a busbar assembly 50 adapted to connect one battery module to another battery module, or to connect a battery module to an ICB.

The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor.

In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of sensing devices 40a-40n is capable of measuring distances in the environment surrounding the vehicle 10.

The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

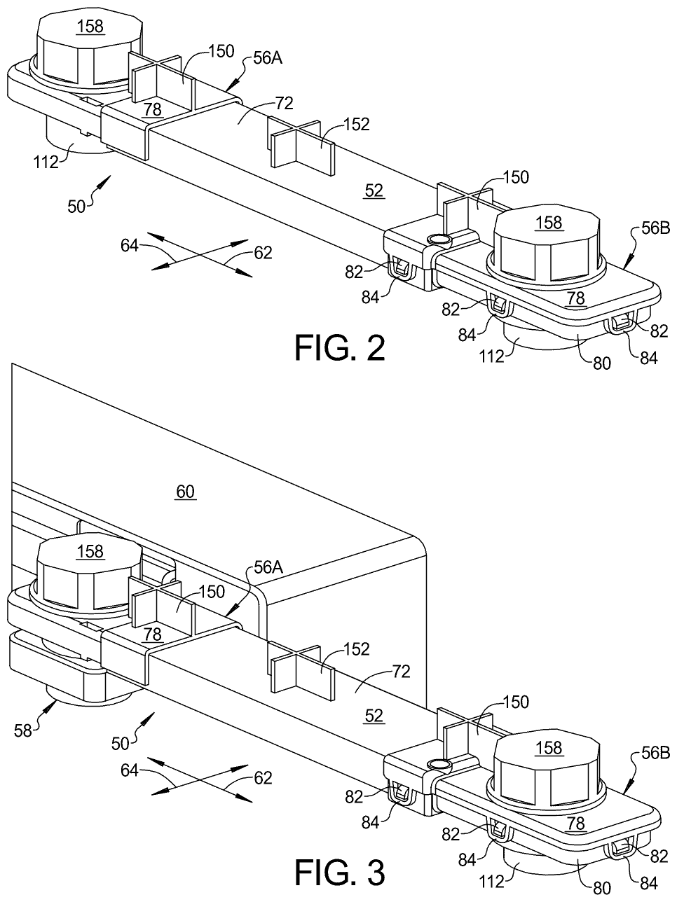

Referring to FIG. 2 and FIG. 3, a busbar assembly 50 according to an exemplary embodiment of the present disclosure includes a busbar 52 having a first distal end 54A and a second distal end 54B. As shown in FIG. 2, the busbar assembly 50 includes a first finger-proof terminal connector 56A positioned on the first distal end 54A of the busbar 52 and a second finger-proof terminal connector 56B positioned on the second distal end 54B of the busbar 52. Each of the first and second finger-proof terminal connectors 56A, 56B is adapted to electrically connect the busbar 52 to an external terminal 58. The external terminal 58 may be a terminal of any module or electronic module within a battery pack utilizing the appropriate terminal design, and may be, by way of non-limiting examples, a battery module 60 or a terminal of an electrical interconnect board (ICB), a BDU, mid pack or fuse block. Thus, the busbar assembly 50 may be used to interconnect two battery modules together in series, or to connect a battery module to an ICB. As shown in FIG. 3, the first finger-proof terminal connector 56A and the first distal end 54A of the busbar 52 are secured to an external terminal 58 of a battery module 60. In other embodiments, the busbar assembly 50 includes only the first finger-proof terminal connector 56A positioned on the first distal end 54A of the busbar and the second distal end 54B of the busbar 52 includes different connection features for connecting the busbar assembly 50 to electrical components within the electrical system 38. It should be understood that the first finger-proof terminal connector 56A and the second finger-proof terminal connector 56B are identical finger-proof terminal connectors 56A, 56B, and the only difference between them is that the first finger-proof terminal connector 56A is positioned on the first distal end 54A of the busbar 52 and the second finger-proof terminal connector 56B is positioned on the second distal end 54B of the busbar 52.

In an exemplary embodiment, when the first finger-proof terminal connector 56A is not connected to an external terminal 58, the first finger-proof terminal connecter 56A is adapted to allow limited movement of the first distal end 54A of the busbar 52 relative to the first finger-proof terminal connector 56A within an x-y plane defined by an x-axis 62 and a y-axis 64, and when the second finger-proof terminal connector 56B is not connected to an external terminal 58, the second finger-proof terminal connecter 56B is adapted to allow limited movement of the second distal end 54B of the busbar 52 relative to the second finger-proof terminal connector 56B within the x-y plane defined by an x-axis 62 and a y-axis 64.

Referring to FIG. 6, wherein FIG. 6 represents the identical first and second distal ends 54A, 54B of the busbar 52, the busbar 52 includes a first slot 66A formed therein and positioned longitudinally along a central axis 68 of the busbar 52 adjacent the first distal end 54A of the busbar 52, and a second slot 70A formed therein and positioned longitudinally along the central axis 68 of the busbar 52 adjacent the first slot 66A, further away from the first distal end 54A of the busbar 52 than the first slot 66A. Likewise, the busbar 52 includes a third slot 66B formed therein and positioned longitudinally along the central axis 68 of the busbar 52 adjacent the second distal end 54B of the busbar 52, and a fourth slot 70B formed therein and positioned longitudinally along the central axis 68 of the busbar 52 adjacent the third slot 66B, further away from the second distal end 54B of the busbar 52 than the third slot 66B.

A protective outer coating 72 extends along a length of the busbar 52. The first distal end 54A of the busbar 52, including the first slot 66A and the second slot 70A, extends beyond the protective outer coating 72, wherein the first finger-proof terminal connector 56A encapsules the first distal end 54A of the busbar 52, including the first slot 66A and the second slot 70A, and extends over a first edge 74 of the protective outer coating 72. The second distal end 54B of the busbar 52, including the third slot 66B and the fourth slot 70B, extends beyond the protective outer coating 72, wherein the second finger-proof terminal connector 56B encapsules the second distal end 54B of the busbar 52, including the third slot 66B and the fourth slot 70B, and extends over a second edge 76 of the protective outer coating 72.

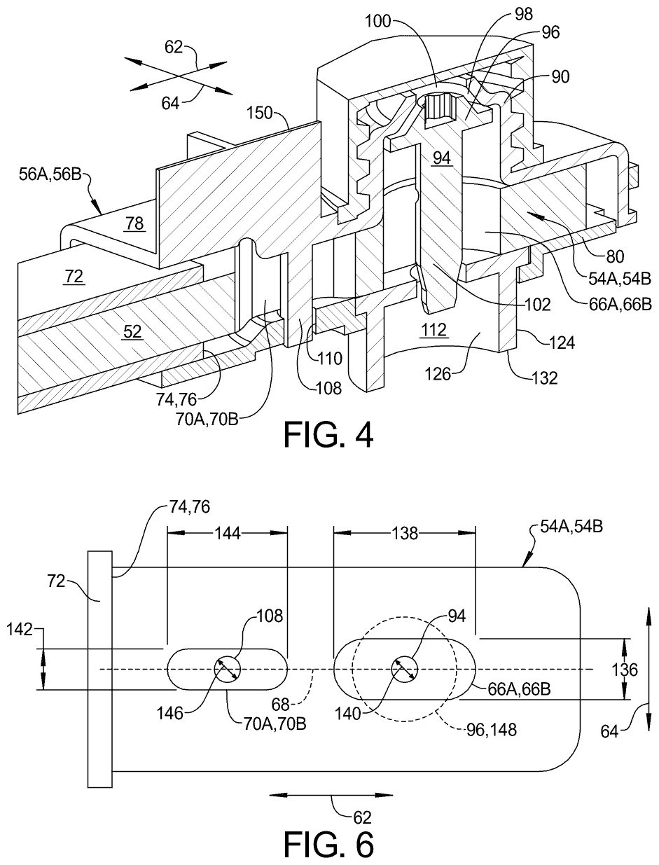

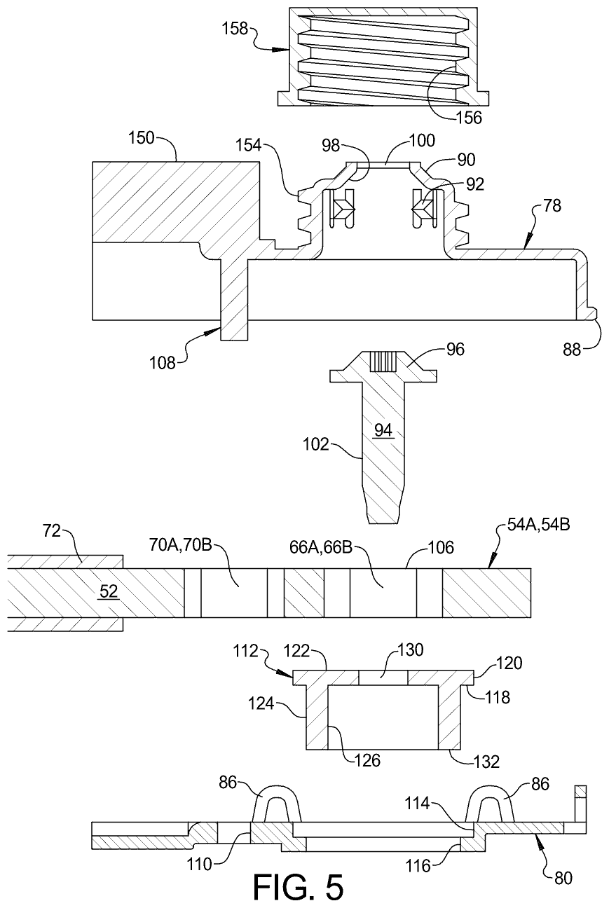

Referring to FIG. 4 and FIG. 5, wherein FIG. 4 represents a sectional view of the identical first and second finger-proof terminal connectors 56A, 56B and FIG. 5 is an exploded view of FIG. 4, each of the first and second finger-proof terminal connectors 56A, 56B includes an upper terminal cap 78 and a lower terminal cap 80, the upper terminal cap 78 and the lower terminal cap 80 including features 82, 84 adapted to secure the upper terminal cap 78 to the lower terminal cap 80 with the first or second distal end 54A, 54B of the busbar 52 encapsulated therebetween. As shown in FIG. 2 and FIG. 3, the lower terminal cap 80 of each of the first and second finger-proof terminal connectors 56A, 56B includes a plurality of clips 82 that are received in corresponding slots 84 extending from the upper terminal cap 78 of each of the first and second finger-proof terminal connectors 56A, 56B. This allows the upper and lower terminal caps 78, 80 to be snapped onto one of the first and second distal ends 54A, 54B of the busbar 52, wherein once placed onto the busbar 52, the clips 82 engage the slots 84 removably securing the upper terminal cap 78 to the lower terminal cap 80, and securing the first and second finger-proof terminal connectors 56A, 56B onto the busbar 52. Manually disengaging the clips 82 of the lower terminal cap 80 from the slots 84 of the upper terminal cap 78 allows the finger-proof terminal connectors 56A, 56B to be removed from the busbar 52. Thus, the first and second finger-proof terminal connectors 56A, 56B may be repeatedly re-used. As shown in FIG. 5, in another exemplary embodiment, the lower terminal cap 80 of each of the first and second finger-proof terminal connectors 56A, 56B includes a plurality of slots 86 that receive corresponding clips 88 extending from the upper terminal cap 78 of each of the first and second finger-proof terminal connectors 56A, 56B.

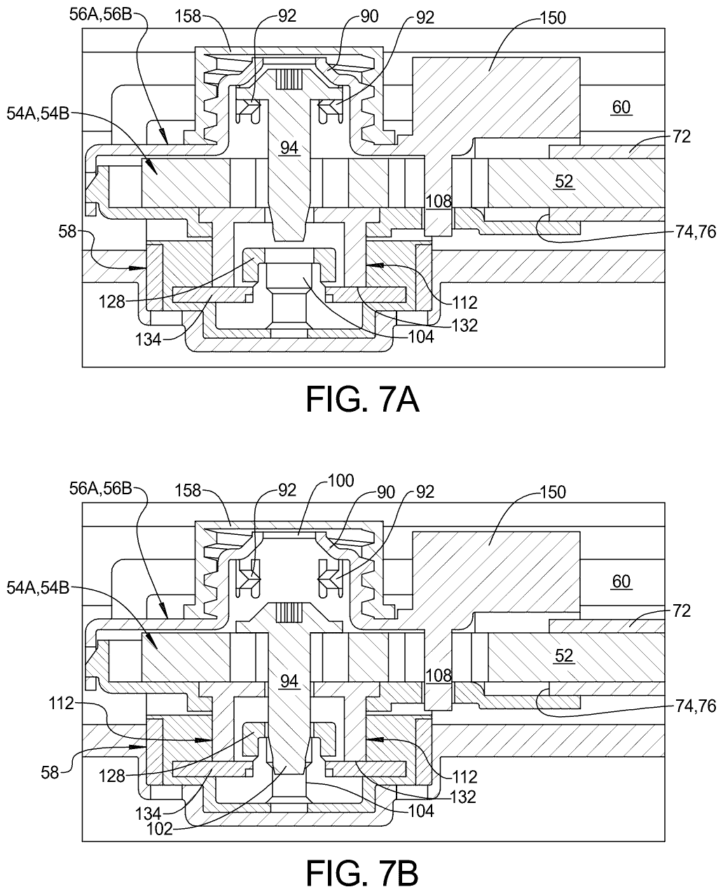

The upper terminal cap 78 of each of the first and second finger-proof terminal connectors 56A, 56B includes a fastener retaining cap 90 with features 92 adapted to rotatably secure a terminal fastener 94 therein, wherein the terminal fastener 94 extends through the first or third slot 66A, 66B within the busbar 52. As shown, a head 96 of the terminal fastener 94 is held near an upper end 98 of the fastener retaining cap 90 by a plurality of inwardly extending flexible fingers 92. The fastener retaining cap 90 further includes an opening 100 formed therein to allow access to the head 96 of the terminal fastener 94. The terminal fastener 94 has an externally threaded shaft 102 that is adapted to engage a threaded bore 104 within an external terminal 58. Thus, referring to FIG. 7A, when the upper terminal cap 78 and the lower terminal cap 80 are snapped onto the busbar 52, the terminal fastener 94 is suspended within the fastener retaining cap 90, extending downward through the first or third slot 66A, 66B within the busbar 52, and when the finger-proof terminal connector 56A, 56B is placed onto an external terminal 58 of the battery module 60, the terminal fastener 94 is aligned with and suspended above the threaded bore 104 within the external terminal 58, as shown in FIG. 7A.

The opening 100 within the fastener retaining cap 90 allows a tool to access the terminal fastener 94, wherein rotation of the terminal fastener 94 causes the external threaded shaft 102 of the terminal fastener 94 to engage the threaded bore 104 of the external terminal 58, wherein, as the terminal fastener 94 threads into the threaded bore 104 of the external terminal 58, the head 96 of the terminal fastener 94 is pulled from the plurality of flexible fingers 92 and disengages from the fastener retaining cap 90. When the terminal fastener 94 is fully threaded into the external terminal 58, the head 96 of the terminal fastener 94 engages a top surface 106 of the busbar 52 and pulls the busbar 52 downward toward the external terminal 58.

The upper terminal cap 78 of each of the first and second finger-proof terminal connectors 56A, 56B further includes an alignment post 108 extending through the second or fourth slot 70A, 70B within the busbar 52 and engaging a limit stop slot 110 formed within the lower terminal cap 80. The alignment post 108 aids in alignment of the upper terminal cap 78 and the lower terminal cap 80 as the upper terminal cap 78 and the lower terminal cap 80 are assembled, and provides structural rigidity of the finger-proof terminal connector 56A, 56B after being assembled.

The lower terminal cap 80 of each of the first and second finger-proof terminal connectors 56A, 56B includes a terminal barrel 112 supported within an aligning pocket 114 formed therein. The aligning pocket 114 is coaxially aligned with the first/third slot 66A, 66B within the busbar 52, the terminal fastener 94 and the fastener retaining cap 90 and includes a radial retaining lip 116 adapted to engage a radial support lip 118 extending around an upper end 120 of the terminal barrel 112 to support the terminal barrel 112 therein.

The terminal barrel 112 is adapted to engage an external terminal 58 and includes a contact face 122 in contact with the busbar 52 and adapted to create an electrical connection therebetween, and a cylindrical body 124 that defines a terminal aligning bore 126 adapted to receive a hub 128 of the external terminal 58 therein. The terminal fastener 94 extends through an orifice 130 within the contact face 122 of the terminal barrel 112 to engage the threaded bore 104 of the hub 128 of the external terminal 58 and secure the busbar 52 in contact with the contact face 122 of the terminal barrel 112, and secure a bottom edge 132 of the body 124 of the terminal barrel 112 in contact with a conducting surface 134 of the external terminal 58, creating an electrical connection between the busbar 52 and the conducting surface 134 of the external terminal 58 through the terminal barrel 112. In other embodiments, wherein the finger-proof terminal connector 56A, 56B is adapted to be connected to an external terminal having a flat conductive surface (no hub), the finger-proof terminal connector 56A, 56B may be used without the terminal barrel 112, wherein the busbar 52 contacts the flat conducting surface 134 directly.

Referring again to FIG. 6, the first slot 66A within the first distal end 54A of the busbar 52 and the third slot 66B within the second distal end 54B of the busbar 52 each have a width 136 and a length 138 that are each larger than a diameter 140 of the terminal fastener 94 extending therethrough. Further, the second slot 70A within the first distal end 54A of the busbar 52 and the fourth slot 70B within the second distal end 54B of the busbar 52 have a width 142 and a length 144 that are each larger than a diameter 146 of the alignment post 108 extending therethrough. Thus, after the upper terminal cap 78 and the lower terminal cap 80 of the first and second finger-proof terminal connectors 56A, 56B are assembled onto the first and second distal ends 54A, 54B of the busbar 52, and prior to the terminal fastener 94 being secured to an external terminal 58, the first distal end 54A of the busbar 52 is moveable relative to the first finger-proof terminal connector 56A within the x-y plane, and the second distal end 54B of the busbar 52 is moveable relative to the second finger-proof terminal connector 56B within the x-y plane.

The width 136 of the first and third slots 66A, 66B within the busbar 52 are smaller than a diameter 148 of the head 96 of the terminal fastener 94. Thus, when the terminal fastener 94 is threaded into the threaded bore 104 of the external terminal 58, the head 96 of the terminal fastener 94 engages the top surface 106 of the busbar 52 to pull the busbar 52 downward toward the external terminal 58.

Dimensional play between the first and third slots 66A, 66B and the terminal fasteners 94 and dimensional play between the third and fourth slots 70A, 70B and the alignment posts 108 allows the distal ends 54A, 54B of the busbar 52 to slide back and forth within the x-y plane defined by the x-axis 62 and the y-axis 64. This allows dimensional errors and imprecise placement and alignment of modules and electrical components that are being interconnected to be accommodated for by the busbar assembly 50.

Referring again to FIG. 2 and FIG. 3, in an exemplary embodiment, the upper terminal cap 78 of each of the first and second finger-proof terminal connectors 56A, 56B includes a first pick and place feature 150 adapted to allow grasping of the busbar assembly 50 by an automated tool. As shown, the first pick and place feature 150 is cross shaped having intersecting fins, one fin aligned along the x-axis 64 and the other fin aligned along the y-axis. The cross shaped first pick and place feature 150 defines a reference point or datum that a robotic/automated tool utilizes for locating the busbar assembly 50. Further, either one or both of the fins of the first pick and place feature define a lift interface onto which a grasping tool of a robotic/automated tool secures the busbar assembly 50 for movement and positioning of the busbar assembly 50. Thus, when the busbar assembly 50 is being supported by an automated tool grasping the first pick and place feature 150 of the upper terminal cap 78, the busbar 52 is moveable relative to the finger-proof terminal connector 56A, 56B within the x-y plane. For example, referring to FIG. 3, when an automated tool grasps the first pick and place feature 150 of the first finger-proof terminal connector 56A at the first distal end 54A of the busbar 52, the first pick and place feature 150 of the first finger-proof terminal connector 56A becomes the reference datum for the automated tool used to position the first finger-proof terminal connector 56A for proper engagement with the external terminal 58 of the battery module 60. To connect the second finger-proof terminal connector 56B to an external terminal of an adjacent battery module or an ICB, the position and alignment of the adjacent battery module or ICB would need to be precise for the second finger-proof terminal connector 56B to properly align with the external terminal of the adjacent battery module or ICB. The sliding planar freedom of movement of the busbar 52 relative to the first finger-proof terminal connector 56A and the sliding planar freedom of movement of the second finger-proof terminal connector 56B relative to the busbar 52 allows the busbar 52 assembly to accommodate slight imprecision in the position of the adjacent battery module. After the first finger-proof terminal connector 56A is connected to the external terminal 58 of the battery module 60, the automated/robotic tool may then be utilized to grasp the first pick and place feature 150 of the second finger-proof terminal connector 56B. When the automated tool grasps the first pick and place feature 150 of the second finger-proof terminal connector 56B at the second distal end 54B of the busbar 52, the first pick and place feature 150 of the second finger-proof terminal connector 56B defines a reference point or datum for the automated tool used to position the second finger-proof terminal connector 56B for proper engagement with an external terminal 58 of an adjacent component. The sliding planar freedom of movement of the busbar 52 relative to the first finger-proof terminal connector 56A and the sliding planar freedom of movement of the second finger-proof terminal connector 56B relative to the busbar 52 allows movement of the second finger-proof terminal connector 56B relative to the first finger-proof terminal connector 56A, and thus, allows the automated/robotic tool to properly position the second finger-proof terminal connector 56B and accommodate slight imprecision in the position of the adjacent component, even after the first finger-proof terminal connector 56A has been secured to the external terminal 58 of the battery module 60. Thus, the busbar assembly 50 provides for robust assembly processes that can accommodate positional imprecision and dimensional tolerancing between adjacent battery modules and making it possible for an automated (robotic) tool to assemble the busbar assembly 50 to adjacent modules.

Further, in another exemplary embodiment, the outer protective coating 72 of the busbar 52 includes a second pick and place feature 152 adapted to allow grasping of the busbar assembly 50 by an automated tool. As shown, the second pick and place feature 152 is cross shaped having intersecting fins, one fin aligned along the x-axis 64 and the other fin aligned along the y-axis. The cross shaped second pick and place feature 152 defines a reference point or datum that a robotic/automated tool utilizes for locating the busbar assembly 50. Further, either one or both of the fins of the second pick and place feature define a lift interface onto which a grasping tool of a robotic/automated tool secures the busbar assembly 50 for movement and positioning of the busbar assembly 50. Thus, when the busbar assembly 50 is being supported by an automated tool grasping the second pick and place feature 152 of the outer protective coating 72 of the busbar 52, the first finger-proof terminal connector 56A is moveable relative to the busbar 52 within the x-y plane and the second finger-proof terminal connector 56B is moveable relative to the busbar 52 within the x-y plane.

For example, when an automated tool grasps the second pick and place feature 152 of the busbar 52, the second pick and place feature 152 of the busbar 52 becomes the reference point or datum for the automated tool used to position the busbar assembly 50, and thus, the first finger-proof terminal connector 56A for proper engagement with an external terminal of a battery module or ICB and to position the second finger-proof terminal connector 56B for proper engagement with an external terminal of an adjacent battery module or ICB. Thus, the position of the busbar 52 is the controlling datum, which may be critical if the busbar 52 is mounted onto structural features within the vehicle 10. To connect the first and second finger-proof terminal connectors 56A, 56B to the external terminals of adjacent battery modules or an ICB, the position of the adjacent battery modules or ICB, relative to the structural feature of the vehicle, would need to be precise. The sliding planar freedom of movement of the first finger-proof terminal connector 56A relative to the busbar 52 allows the busbar assembly 50 to accommodate slight imprecision in the position of battery module or ICB onto which the first finger-proof terminal connector 56A is to be connected. The sliding planar freedom of movement of the second finger-proof terminal connector 56B relative to the busbar 52 allows the busbar assembly 50 to accommodate slight imprecision in the position of the battery module or ICB onto which the second finger-proof terminal connector 56B is to be connected. Thus, the busbar assembly 50 provides for robust assembly processes that can accommodate positional imprecision and dimensional tolerancing between adjacent battery modules and making it possible for an automated (robotic) tool to assemble the busbar assembly 50 to adjacent modules, ICB or structural features of the vehicle 10.

In an exemplary embodiment, the fastener retaining cap 90 of each of the first finger-proof terminal connector 56A and the second finger-proof terminal connector 56B includes external threads 154 adapted to engage internal threads 156 of a pyrophoric cap 158. The pyrophoric cap 158 has a hexagonal shape adapted to allow engagement with tooling, either manually or by automation, to selectively assemble or remove the pyrophoric cap 158 from the fastener retaining cap 90. The pyrophoric cap 158 is adapted to removably cover the opening 100 within the fastener retaining cap 90 that is adapted to allow access to the terminal fastener 94. Thus, once the upper terminal cap 78 and the lower terminal cap 80 are snapped together, encapsulating the distal end 54A, 54B of the busbar 52 therein, and the finger-proof terminal connector 56A, 56B is placed onto an external terminal 58 and the terminal fastener 94 is threaded into the external terminal 58, the pyrophoric cap 158 is placed onto the fastener retaining cap 90 to cover the opening 100 therein.

The protective outer coating 72 of the busbar 52, the upper terminal cap 78, the lower terminal cap 80 and the pyrophoric cap 158 are all made from a non-conductive material such that when the busbar assembly 50 is placed onto adjacent modules to conduct electrical current therebetween, the busbar assembly 50 prevents inadvertent contact with electrified surfaces by people or tools.

A busbar assembly 50 of the present disclosure offers several advantages. These include providing electrical insulation of electrified surfaces when used to interconnect electrical components and accommodating dimensional, positional and alignment imprecision of modules to be interconnected with the busbar assembly 50, which enables robust automated assembly of the busbar assembly 50 to battery modules and ICBs.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A busbar assembly for interconnecting components within a multi-module electrical system for a vehicle, comprising:
a busbar having a first distal end and a second distal end; and
a first finger-proof terminal connector positioned on the first distal end of the busbar and adapted to electrically connect the busbar to an external terminal, wherein the finger-proof terminal connecter is adapted to allow limited movement of the first distal end of the busbar relative to the first finger-proof terminal connector within an x-y plane.

2. The busbar assembly of claim 1, wherein the busbar includes:
a first slot formed therein and positioned longitudinally along a central axis of the busbar adjacent the first distal end of the busbar;
a second slot formed therein and positioned longitudinally along the central axis of the busbar adjacent the first slot; and
a protective outer coating extending along a length of the busbar, the first distal end of the busbar, including the first slot and the second slot, extending beyond the protective outer coating, wherein the finger-proof terminal connector encapsules the first distal end of the busbar, including the first slot and the second slot, and extends over a first edge of the protective outer coating.

3. The busbar assembly of claim 2, wherein the first finger-proof terminal connector includes:
an upper terminal cap and a lower terminal cap, the upper terminal cap and the lower terminal cap including features adapted to secure the upper cap to the lower cap with the first distal end of the busbar encapsulated therebetween;
the upper terminal cap of the first finger-proof terminal connector including:
a fastener retaining cap with features adapted to rotatably secure a terminal fastener therein, wherein the terminal fastener extends through the first slot within the busbar;
an alignment post extending through the second slot within the busbar and engaging a limit stop slot formed within the lower terminal cap;
the lower terminal cap of the first finger-proof terminal connector including a terminal barrel supported within an aligning pocket formed therein, the terminal barrel adapted to engage an external terminal and including a contact face in contact with the busbar and adapted to create an electrical connection therebetween, wherein the terminal fastener extends through the contact face of the terminal barrel and is adapted to engage an external terminal and secure the first distal end of the busbar and the first finger-proof terminal connector to the external terminal and creating an electrical connection between the busbar and the external terminal through the terminal barrel.

4. The busbar assembly of claim 3, wherein the first slot has a width and a length that are each larger than a diameter of the terminal fastener extending therethrough, and the second slot has a width and a length that are each larger than a diameter of the alignment post extending therethrough, wherein prior to the terminal fastener being secured to an external terminal, the first distal end of the busbar is moveable relative to the first finger-proof terminal connector within the x-y plane.

5. The busbar assembly of claim 4, wherein the upper terminal cap of the first finger-proof terminal connector includes a pick and place feature adapted to allow grasping of the busbar assembly by an automated tool, wherein, when the busbar assembly is being supported by an automated tool grasping the pick and place feature of the upper terminal cap of the first finger-proof terminal connector, the busbar is moveable relative to the first finger-proof terminal connector within the x-y plane.

6. The busbar assembly of claim 5, wherein the outer protective cover of the busbar includes a pick and place feature adapted to allow grasping of the busbar assembly by an automated tool, wherein, when the busbar assembly is being supported by an automated tool grasping the pick and place feature of the outer protective coating of the busbar, the first finger-proof terminal connector is moveable relative to the busbar within the x-y plane.

7. The busbar assembly of claim 6 further including a second finger-proof terminal connector positioned on the second distal end of the busbar and adapted to electrically connect the busbar to an external terminal, wherein the second finger-proof terminal connecter is adapted to allow limited movement of the second distal end of the busbar relative to the second finger-proof terminal connector within the x-y plane.

8. The busbar assembly of claim 7, wherein the busbar includes:
a third slot formed therein and positioned longitudinally along the central axis of the busbar adjacent the second distal end of the busbar; and
a fourth slot formed therein and positioned longitudinally along the central axis of the busbar adjacent the third slot; and
wherein, the protective outer coating extends along a length of the busbar, the second distal end of the busbar, including the third slot and the fourth slot, extending beyond the protective outer coating, wherein the second finger-proof terminal connector encapsules the second distal end of the busbar, including the third slot and the fourth slot, and extends over a second edge of the protective outer coating.

9. The busbar assembly of claim 8, wherein the second finger-proof terminal connector includes:
an upper terminal cap and a lower terminal cap, the upper terminal cap and the lower terminal cap including features adapted to secure the upper cap to the lower cap with the second distal end of the busbar encapsulated therebetween;
the upper terminal cap of the second finger-proof terminal connector including:
a fastener retaining cap with features adapted to rotatably secure a terminal fastener therein, wherein the terminal fastener extends through the third slot within the busbar;
an alignment post extending through the fourth slot within the busbar and engaging a limit stop slot formed within the lower terminal cap of the second finger-proof terminal connector;
the lower terminal cap of the second finger-proof terminal connector including a terminal barrel supported within an aligning pocket formed therein, the terminal barrel adapted to engage an external terminal and including a contact face in contact with the busbar and adapted to create an electrical connection therebetween, wherein the terminal fastener extends through the contact face of the terminal barrel and is adapted to engage an external terminal and secure the second distal end of the busbar and the second finger-proof terminal connector to the external terminal and creating an electrical connection between the busbar and the external terminal through the terminal barrel.

10. The busbar assembly of claim 9, wherein the third slot has a width and a length that are each larger than a diameter of the terminal fastener extending therethrough, and the fourth slot has a width and a length that are each larger than a diameter of the alignment post extending therethrough, wherein prior to the terminal fastener being secured to an external terminal, the second distal end of the busbar is moveable relative to the second finger-proof terminal connector within the x-y plane.

11. The busbar assembly of claim 10, wherein the upper terminal cap of the second finger-proof terminal connector includes a pick and place feature adapted to allow grasping of the busbar assembly by an automated tool, wherein, when the busbar assembly is being supported by an automated tool grasping the pick and place feature of the upper terminal cap of the second finger-proof terminal connector, the busbar is moveable relative to the second finger-proof terminal connector within the x-y plane; and
when the busbar assembly is being supported by an automated tool grasping the pick and place feature of the outer protective coating of the busbar, each of the first finger-proof terminal connector and the second finger-proof terminal connector is independently moveable relative to the busbar within the x-y plane.

12. The busbar of claim 11, wherein the fastener retaining cap of each of the first finger-proof terminal connector and the second finger-proof terminal connector includes external threads adapted to engage internal threads of a pyrophoric cap, the pyrophoric cap adapted to removably cover an opening within the fastener retaining cap, the opening within the fastener retaining cap adapted to allow access to the terminal fastener.

13. A busbar assembly for interconnecting components within a multi-module electrical system for a vehicle, comprising:
a busbar having a first distal end and a second distal end;
a first finger-proof terminal connector positioned on the first distal end of the busbar and adapted to electrically connect the busbar to an external terminal, wherein the finger-proof terminal connecter is adapted to allow limited movement of the first distal end of the busbar relative to the first finger-proof terminal connector within an x-y plane; and
a second finger-proof terminal connector positioned on the second distal end of the busbar and adapted to electrically connect the busbar to an external terminal, wherein the second finger-proof terminal connecter is adapted to allow limited movement of the second distal end of the busbar relative to the second finger-proof terminal connector within the x-y plane.

14. The busbar assembly of claim 13, wherein the busbar includes:
a first slot formed therein and positioned longitudinally along a central axis of the busbar adjacent the first distal end of the busbar;
a second slot formed therein and positioned longitudinally along the central axis of the busbar adjacent the first slot;
a third slot formed therein and positioned longitudinally along the central axis of the busbar adjacent the second distal end of the busbar;
a fourth slot formed therein and positioned longitudinally along the central axis of the busbar adjacent the third slot;
a protective outer coating extending along a length of the busbar;
the first distal end of the busbar, including the first slot and the second slot, extending beyond the protective outer coating, wherein the first finger-proof terminal connector encapsules the first distal end of the busbar, including the first slot and the second slot, and extends over a first edge of the protective outer coating; and
the second distal end of the busbar, including the third slot and the fourth slot, extending beyond the protective outer coating, wherein the second finger-proof terminal connector encapsules the second distal end of the busbar, including the third slot and the fourth slot, and extends over a second edge of the protective outer coating.

15. The busbar assembly of claim 14, wherein the first finger-proof terminal connector is substantially identical to the second finger-proof terminal connector, each of the first finger-proof terminal connector and the second finger-proof terminal connector including:
an upper terminal cap and a lower terminal cap, the upper terminal cap and the lower terminal cap including features adapted to secure the upper cap to the lower cap with the distal end of the busbar encapsulated therebetween;
the upper terminal cap of each of the first finger-proof terminal connector and the second finger-proof terminal connector including:
a fastener retaining cap with features adapted to rotatably secure a terminal fastener therein, wherein the terminal fastener of the first finger-proof terminal connector extends through the first slot within the busbar and the terminal fastener of the second finger-proof terminal connector extends through the third slot within the busbar;
an alignment post, the alignment post of the first finger-proof terminal connector extending through the second slot within the busbar and engaging a limit stop slot formed within the lower terminal cap of the first finger-proof terminal connector, and the alignment post of the second finger-proof terminal connector extending through the fourth slot within the busbar and engaging a limit stop slot formed within the lower terminal cap of the second finger-proof terminal connector;
the lower terminal cap of each of the first finger-proof terminal connector and the second finger-proof terminal connector including a terminal barrel supported within an aligning pocket formed therein, the terminal barrel of each of the first finger-proof terminal connector and the second finger-proof terminal connector adapted to engage an external terminal and including a contact face in contact with the busbar and adapted to create an electrical connection therebetween;
wherein the terminal fastener of the first finger-proof terminal connector extends through the contact face of the terminal barrel and is adapted to engage an external terminal and secure the first distal end of the busbar and the first finger-proof terminal connector to the external terminal and create an electrical connection between the first distal end of the busbar and the external terminal through the terminal barrel; and
the terminal fastener of the second finger-proof terminal connector extends through the contact face of the terminal barrel and is adapted to engage an external terminal and secure the second distal end of the busbar and the second finger-proof terminal connector to the external terminal and create an electrical connection between the second distal end of the busbar and the external terminal through the terminal barrel.

16. The busbar assembly of claim 15, wherein:
the first slot has a width and a length that are each larger than a diameter of the terminal fastener of the first finger-proof terminal connector extending therethrough, and the second slot has a width and a length that are each larger than a diameter of the alignment post of the first finger-proof terminal connector extending therethrough, wherein prior to the terminal fastener of the first finger-proof terminal connector being secured to an external terminal, the first distal end of the busbar is moveable relative to the first finger-proof terminal connector within the x-y plane; and
the third slot has a width and a length that are each larger than a diameter of the terminal fastener of the third finger-proof terminal connector extending therethrough, and the fourth slot has a width and a length that are each larger than a diameter of the alignment post of the second finger-proof terminal connector extending therethrough, wherein prior to the terminal fastener of the second finger-proof terminal connector being secured to an external terminal, the second distal end of the busbar is moveable relative to the second finger-proof terminal connector within the x-y plane.

17. The busbar assembly of claim 16, wherein:
the upper terminal cap of the first finger-proof terminal connector includes a pick and place feature adapted to allow grasping of the busbar assembly by an automated tool, wherein, when the busbar assembly is being supported by an automated tool grasping the pick and place feature of the upper terminal cap of the first finger-proof terminal connector, the busbar is moveable relative to the first finger-proof terminal connector within the x-y plane;
the upper terminal cap of the second finger-proof terminal connector includes a pick and place feature adapted to allow grasping of the busbar assembly by an automated tool, wherein, when the busbar assembly is being supported by an automated tool grasping the pick and place feature of the upper terminal cap of the second finger-proof terminal connector, the busbar is moveable relative to the second finger-proof terminal connector within the x-y plane; and
the outer protective cover of the busbar includes a pick and place feature adapted to allow grasping of the busbar assembly by an automated tool, wherein, when the busbar assembly is being supported by an automated tool grasping the pick and place feature of the outer protective coating of the busbar, each of the first finger-proof terminal connector and the second finger-proof terminal connector are independently moveable relative to the busbar within the x-y plane.

18. The busbar of claim 11, wherein the fastener retaining cap of each of the first finger-proof terminal connector and the second finger-proof terminal connector includes external threads adapted to engage internal threads of a pyrophoric cap;
a pyrophoric cap of the first finger-proof terminal connector adapted to removably cover an opening within the fastener retaining cap of the first finger proof terminal connector that is adapted to allow access to the terminal fastener of the first finger-proof terminal connector; and
a pyrophoric cap of the second finger-proof terminal connector adapted to removably cover an opening within the fastener retaining cap of the second finger proof terminal connector that is adapted to allow access to the terminal fastener of the second finger-proof terminal connector.

19. A vehicle including a busbar assembly for interconnecting components within a multi-module electrical system, the busbar assembly comprising:
a busbar including:
a first distal end and a second distal end;
a first slot positioned longitudinally along a central axis of the busbar adjacent the first distal end;
a second slot positioned longitudinally along the central axis of the busbar adjacent the first slot;
a third slot positioned longitudinally along the central axis of the busbar adjacent the second distal end; and
a fourth slot positioned longitudinally along the central axis of the busbar adjacent the third slot;
a protective outer coating extending along a length of the busbar, the first distal end of the busbar, including the first slot and the second slot, extending beyond the protective outer coating and the second distal end of the busbar, including the third slot and the fourth slot, extending beyond the protective outer coating;
a first finger-proof terminal connector positioned on the first distal end of the busbar and adapted to electrically connect the busbar to an external terminal, and a second finger-proof terminal connector positioned on the second distal end of the busbar and adapted to electrically connect the busbar to an external terminal, each of the first and second finger-proof terminal connectors including:
an upper terminal cap and a lower terminal cap, the upper terminal cap and the lower terminal cap including features adapted to secure the upper cap to the lower cap with the first distal end of the busbar, including the first and second slots encapsulated between the upper terminal cap and the lower terminal cap of the first finger-proof terminal connector and the second distal end of the busbar, including the third and fourth slots encapsulated between the upper terminal cap and the lower terminal cap of the second finger-proof terminal connector;
each upper terminal cap including:
a fastener retaining cap with features adapted to rotatably secure a terminal fastener therein, wherein the terminal fastener of the first finger-proof terminal connector extends through the first slot within the busbar and the terminal fastener of the second finger-proof terminal connector extends through the third slot within the busbar; and
an alignment post, the alignment post of the first finger-proof terminal connector extending through the second slot within the busbar and engaging a limit stop slot formed within the lower terminal cap of the first finger-proof terminal connector, and the alignment post of the second finger-proof terminal connector extending through the fourth slot within the busbar and engaging a limit stop slot formed within the lower terminal cap of the second finger-proof terminal connector;
wherein, each of the first slot and the third slot has a width and a length that are each larger than a diameter of the terminal fastener extending therethrough, and each of the second slot and the fourth slot has a width and a length that are each larger than a diameter of the alignment post extending therethrough, wherein the first distal end of the busbar is moveable relative to the first finger-proof terminal connector within an x-y plane and the second distal end of the busbar is moveable relative to the second finger-proof terminal connector within the x-y plane;
each lower terminal cap including a terminal barrel supported within an aligning pocket formed therein, the terminal barrel adapted to engage an external terminal and including a contact face in contact with the busbar and adapted to create an electrical connection therebetween;
wherein the terminal fastener extends through the contact face of the terminal barrel and is adapted to engage an external terminal and secure one of the first and second distal ends of the busbar and the corresponding one of the first and second finger-proof terminal connectors to an external terminal and create an electrical connection between the busbar and the external terminal through the terminal barrel.

20. The vehicle of claim 19, wherein:
the upper terminal cap of each of the first and second finger-proof terminal connectors includes a first pick and place feature adapted to allow grasping of the busbar assembly by an automated tool, and the fastener retaining cap of each of the first and second finger-proof terminal connectors includes external threads adapted to engage internal threads of a pyrophoric cap that is adapted to removably cover an opening within the fastener retaining cap that is adapted to allow access to the terminal fastener; and
the outer protective cover of the busbar includes a second pick and place feature adapted to allow grasping of the busbar assembly by an automated tool.
